(19) United States
(12) Patent Application Publication
(10) Pub. No.: US 2017/0371727 A1
(43) Pub. Date: Dec. 28, 2017

(54) EXECUTION OF INTERACTION FLOWS

(71) Applicant: HEWLETT PACKARD ENTERPRISE DEVELOPMENT LP, Houston, TX (US)

(72) Inventors: Inbar Shani, Yehud (IL); Olga Kogan, Yehud (IL); Amichai Nitsan, Yehud (IL)

(21) Appl. No.: 15/535,235

(22) PCT Filed: Dec. 22, 2014
(86) PCT No.: PCT/US2014/071795

§ 371 Date: Jun. 12, 2017

(51) Int. Cl. G06F 9/54; G06F 9/445; G06F 15/16; H04L 29/08

(52) U.S. Cl. CPC G06F 9/547; H04L 67/34; G06F 9/445; G06F 15/16

(57) ABSTRACT

Examples relate to execution of interaction flows. The examples disclosed herein enable obtaining, via a user interface of a local client computing device, an interaction flow that defines an order of execution of a plurality of interaction points and values exchanged among the plurality of interaction points, the plurality of interaction points comprising a first interaction point that indicates an event executed by an application; triggering the execution of the interaction flow; determining whether any of remote client computing devices that are in communication with the local client computing device includes the application; and causing the first interaction point to be executed by the application in at least one of the remote client computing devices that are determined to include the application.

### BACKGROUND

Modern applications run on various types of computing devices such as a desktop, laptop, tablet, mobile phone, television, and in-car computing system. Such applications typically provide a capability that is focused on a narrow range of tasks. For example, a map application may provide a capability focused on map exploration and navigation. A calendar application may be used to manage meetings and other events. To listen to music, a music player application can be initiated.

### BRIEF DESCRIPTION OF THE DRAWINGS

The following detailed description references the drawings, wherein:

FIG. 1 is a block diagram depicting an example environment in which various examples may be implemented as an interaction flows execution system.

FIG. 2 is a block diagram depicting an example interaction flows execution system.

FIG. 3 is a block diagram depicting an example machine-readable storage medium comprising instructions executable by a processor for execution of interaction flows.

FIG. 4 is a block diagram depicting an example machine-readable storage medium comprising instructions executable by a processor for execution of interaction flows.

FIG. 5 is a flow diagram depicting an example method for execution of interaction flows.

FIG. 6 is a flow diagram depicting an example method for execution of interaction flows.

### DETAILED DESCRIPTION

The following detailed description refers to the accompanying drawings. Wherever possible, the same reference numbers are used in the drawings and the following description to refer to the same or similar parts. It is to be expressly understood, however; that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

Modern applications run on various types of computing devices such as a desktop, laptop, tablet, mobile phone, television, and in-car computing system. Such applications typically provide a capability that is focused on a narrow range of tasks. For example, a map application may provide a capability focused on map exploration and navigation. A calendar application may be used to manage meetings and other events. To listen to music, a music player application can be initiated. However, the applications fail to interact across different applications on the same computing device or across different computing devices.

Examples disclosed herein provide technical solutions to these technical challenges by enabling users to define interaction points to be executed by applications and an overall flow of such interaction points across multiple applications and across multiple computing devices. The examples disclosed herein enable obtaining, via a user interface of a local client computing device, an interaction flow that defines an order of execution of a plurality of interaction points and values exchanged among the plurality of interaction points, the plurality of interaction points comprising a first interaction point that indicates an event executed by an application; triggering the execution of the interaction flow; determining whether any of remote client computing devices that are in communication with the local client computing device includes the application; and causing the first interaction point to be executed by the application in at least one of the remote client computing devices that are determined to include the application.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise.

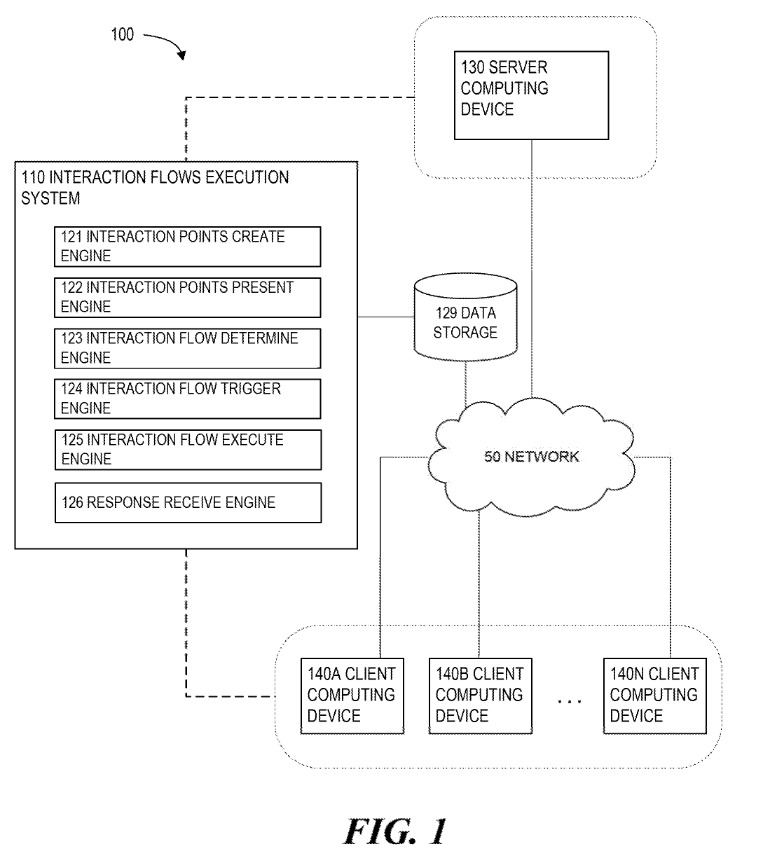

FIG. 1 is an example environment 100 in which various examples may be implemented as an interaction flows execution system 110. Environment 100 may include various components including server computing device 130 and client computing devices 140 (illustrated as 140A, 140B, . . . , 140N). Each client computing device 140A, 140B, . . . , 140N may communicate requests to and/or receive responses from server computing device 130. Server computing device 130 may receive and/or respond to requests from client computing devices 140. Client computing devices 140 may be any type of computing device providing a user interface through which a user can, interact with a software application. For example, client computing devices 140 may include a laptop computing device, a desktop computing device, an all-in-one computing device, a tablet computing device, a mobile phone, an electronic book reader, a network-enabled appliance such as a “Smart” television, and/or other electronic device suitable for displaying a user interface and processing user interactions with the displayed interface. While server computing device 130 is depicted as a single computing device, server computing device 130 may include any number of integrated or distributed computing devices serving at least one software application for consumption by client computing devices 140.

The various components (e.g., components 129, 130, and/or 140) depicted in FIG. 1 may be coupled to at least one other component via a network 50. Network 50 may comprise any infrastructure or combination of infrastructures that enable electronic communication between the components. For example, network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, a peer-to-peer (P2P) network, a Bluetooth network, a near field communication (NEC) network, and/or other network. According to various implementations, interaction flows execution system 110 and, the various components described herein may be implemented in hardware and/or a combination of hardware and programming that configures hardware. Furthermore, in FIG. 1 and other Figures described herein, different numbers of components or entities than depicted may be used.

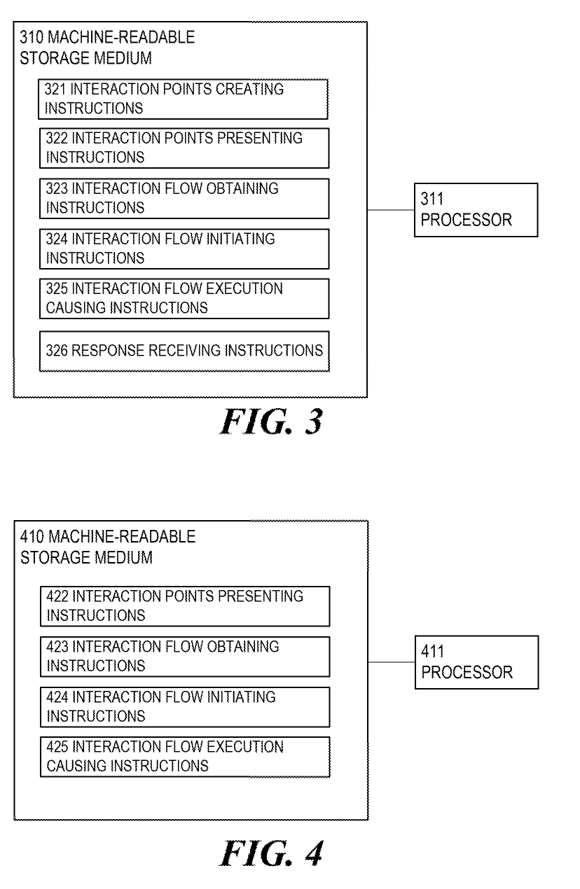

Interaction flows execution system 110 may comprise an interaction points create engine 121, an interaction points present engine 122, an interaction flow determine engine 123, an interaction flow trigger engine 124, an interaction flow execute engine 125, and a response receive engine 126, and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored on the machine-readable storage medium and executable by the processor to perform the designated function.

An “interaction point,” as used herein, may indicate an event executed by an application. The “application,” as used herein, may comprise any software program including mobile applications. For example, an email application may be associated with various interaction points including an interaction point to launch the email application, an interaction point to display an email, an interaction point to compose an email, and so on. In another example, a network connection application (e.g., WiFi application) may be associated with an interaction point to detect when a network connection is available. In another example, a calendar application may be associated with an interaction point to create, modify, or delete a meeting, an interaction point to create, modify, or delete a task, and/or other interaction points to handle other calendar functions or events. In some instances, the interaction point may indicate a state of a device sensor (e.g., network connection sensor, GPS sensor, altitude sensor, accelerometer sensor, microphone sensor, camera sensor, etc.) resided in a computing device.

Such interaction points may be system-generated and/or created based on user input. Accordingly, even if an application does not include a pre-built capability to interact with other applications, a user may define interaction points and publish and/or register those interaction points as discussed herein with respect to interaction points create engine 121.

Interaction points create engine 121 may obtain attributes associated with an interaction point to create the interaction point for an application. The attributes may comprise at least one of an interaction type or category, an interaction name (e.g., “Email Launch”), a set of input values (e.g., that are used by the application to execute the interaction point), a set of output values (e.g., that are outputted as a result of the execution of the interaction point), a interaction fulfillment type (e.g., unique, first-come, all, etc.), interaction security provisions (e.g., encryption requirement, authentication requirement, etc.), and/or other attributes. Based on the obtained attributes, interaction points create engine 121 may create (e.g., define, publish, and/or register) the interaction point for the application.

In some implementations, a set of local interactions points that are created for at least one application running on a first (or local) client computing device (e.g., client computing device 140A) may be stored in a data storage (e.g., data storage 129) coupled to that client computing device. For example, when the user creates the interaction point to display an email that is associated with the email application running on a mobile phone, the interaction point (e.g., that is executable in the mobile phone) may be stored in a data storage resided in the mobile phone.

In some implementations, the first (or local) client computing device may store not only a set of local interaction points (e.g., local to the first client computing device) but also a set of external interaction points that are executable in at least one remote client computing device (e.g., a second client computing device) that may be in communication with the first client computing device over a network (e.g., network 50). For example, when the connection between the first client computing device and the second client computing device is established, the set of interactions points that are local to the second client computing device may be transferred from the second client computing device and/or stored in the first client computing device. In some instances, the set of interactions points associated with the second client computing device may remain stored in the first client computing device after the second client computing device is disconnected from the first client computing device. The first client computing device may communicate with at least one remote client computing device directly via a P2P network, NFC network, and/or other local network, via an intermediate device that establishes the communication, and/or via a server computing device (e.g., server computing device 130).

In some implementations, a server computing device (e.g., server computing device 130) may store such interaction points that are created by interaction points create engine 121. For example, the first and second sets of interactions points as discussed above may be stored in data storage 129 coupled to server computing device 130.

Interaction points present engine 122 may present, via a user interface of a client computing device (e.g., the first client computing device), the interaction points created by interaction points create engine 121. The interaction points that are presented may include, for example, the first set of interactions points (e.g., the set of local interaction points) and/or second set of interaction points (e.g., the set of external interaction points) as discussed above.

Interaction flow determine engine 123 may obtain, determine, and/or create an interaction flow of execution of a plurality of interaction points. The plurality of interaction points may be selected, for example, from the first and/or second sets of interaction points. The “interaction flow,” as used herein, may define an order of execution of the plurality of interaction points and/or values exchanged among the plurality of interaction points. The plurality of interaction points may be executed in sequential order and/or in parallel order. For example, some of the plurality of interactions points may be executed in parallel while the other interaction points may occur in a sequential manner.

The user may, via the user interface of the first client computing device, select the plurality of interaction points that the user wants to use to create this user-defined interaction flow. For example, the plurality of interaction points selected may comprise a first interaction point to detect when a network connection is available on the mobile phone, a second interaction point to launch the email application in the mobile phone, a third interaction point to display an email in the email application in the mobile phone, and a fourth interaction point to display the same email in the email application in a remote client computing device such as a television. The user may define and/or specify the order of execution of the first, second, third, and fourth interaction points. For example, the first, second, third, and fourth interactions points may be arranged in sequential order in the interaction flow. In some instances, at least some of the plurality of interaction points may be executed in parallel order. For example, the third and fourth interactions points may be executed in parallel such that the email may be displayed in the mobile phone and the television at the same time.

In some implementations, interaction flow determine engine 123 may specify which of the plurality of interaction points should be executed in the first (or local) chant computing device only, which of the plurality of interaction points should be executed in all of the remote client computing devices that are in communication with the first client computing device over the network, which of the plurality of interaction points should be executed in a particular remote client computing device (e.g., a television at the user's home), and/or which of the plurality of interaction points should be executed in all devices that are in communication with the first client computing device over the network.

In some implementations, interaction flow determine engine 123 may define and/or specify the values exchanged among the plurality of interaction points. Continuing with the example discussed above, the third and fourth interaction points to display the email in the email application may require the input value comprising the content of the email. The content of the email may be provided by the second interaction point as the output value of the second interaction point.

In some implementations, interaction flow determine engine 123 may create a new interaction flow (e.g., a second interaction flow) by modifying a pre-existing interaction flow (e.g., the first interaction flow) and/or combining the pre-existing interaction flow with another pre-existing interaction flow (e.g., a third interaction flow).

Interaction flow trigger engine 124 may trigger the execution of the interaction flow. In some implementations, the execution of the interaction flow may be triggered by initiating the interaction point that is placed at the beginning of the interaction flow. Using the above example, the execution of the interaction flow may be triggered when the network connection application detects that a network connection is available, fulfilling the execution of the first interaction point. In some implementations, the execution of the interaction flow may be triggered based on an occurrence of a predefined condition. For example, when an internal, device sensor such as a WiFi sensor is connected to a specific network (e.g., the user's home network), this state of the sensor and/or the state indicated by this sensor may trigger the execution of the interaction flow. In another example, the predefined condition may be related to the state of a camera sensor. The condition may be defined such that when the camera is turned on, a particular interaction flow may be executed.

Interaction flow execute engine 125 may execute the interaction flow and/or cause the interaction flow to be executed based on the trigger. In some implementations, the interaction flow may include an interaction point that has been specified to be executed in a particular remote client computing device (e.g., a television at the user's home as discussed herein with respect to interaction flow determine engine 123). For example, interaction flow execute engine 125 may determine whether that particular remote client computing device is currently connected to the first (or local) client computing device over the network. If the particular remote client computing device is available on the network, interaction flow execute engine 125 may cause the remote client computing device (or the application associated with the interaction point in the remote device) to execute the interaction point. In some implementations, the interaction flow may include an interaction point that has been specified to be executed in all of the remote client computing devices that are in communication with the first (or local) client computing device over the network. Interaction flow execute engine 125 may, for example, determine whether any of the remote client computing devices includes the application that is associated with that interaction point. In this example, the interaction point to display the email may be executed in the remote client computing devices that are determined to include the email application.

When the interaction point is specified to be executed in at least one remote client computing device, interaction flow execute engine 125 may create a request to execute the interaction point and/or send the request to the at least one remote client computing device. Upon receiving the request, the at least one remote client computing device may proceed with executing the interaction point.

Response receive engine 126 may receive, from the at least one remote client computing device, a response that indicates that the interaction point has been successfully executed by the application in the remote client computing device or that the application has failed to execute the interaction point. Based on the response that it has been successfully executed, interaction flow execute engine 125 may proceed with executing the next interaction point in the interaction flow. If the response indicates that the application has failed to execute the interaction point, the failure can be further investigated and/or mitigated.

In performing their respective functions, engines 121-126 may access data storage 129 and/or other suitable database(s). Data storage 129 may represent any memory accessible to interaction flows execution system 110 that can be used to store and retrieve data. Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. Interaction flows execution system 110 may access data storage 129 locally or remotely via network 50 or other networks.

Data storage 129 may include a database to organize and store data. Database 129 may be, include, or interface to, for example, an Oracle™ relational database sold commercially by Oracle Corporation. Other databases, such as Informix™, DB2 (Database 2) or other data storage, including file-based (e.g., comma or tab separated files); or query formats, platforms, or resources such as OLAP (On Line Analytical Processing), SQL (Structured Query Language), a SAN (storage area network), Microsoft Access™, MySQL, PostgreSQL, HSpace, Apache Cassandra, MongoDB, Apache CouchDB™, or others may also be used, incorporated, or accessed. The database may reside in a single or multiple physical device(s) and in a single or multiple physical location(s). The database may store a plurality of types of data and/or files and associated data or the description, administrative information, or any other data.

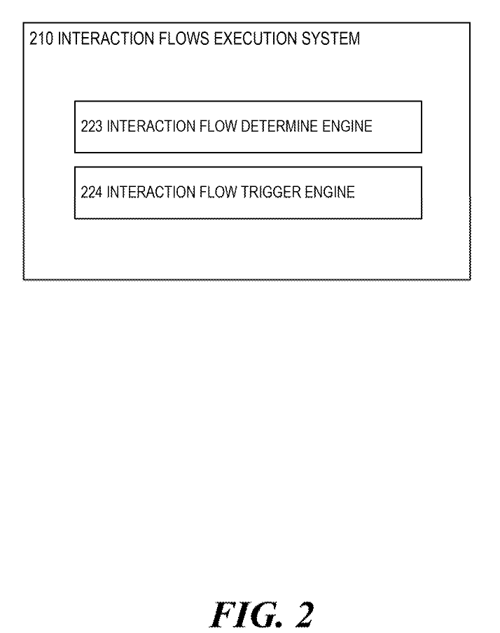

FIG. 2 is a block diagram depicting an example interaction flows execution system 210, interaction flows execution system 210 may comprise an interaction flow determine engine 223, an interaction flow trigger engine 224, and/or other engines. Engines 223-224 represent engines 123-124, respectively.

FIG. 3 is a block diagram depicting an example machine-readable storage medium 310 comprising instructions executable by a processor for execution of interaction flows.

In the foregoing discussion, engines 121-126 were described as combinations of hardware and programming. Engines 121-126 may be implemented in a number of fashions. Referring to FIG. 3, the programming may be processor executable instructions 321-326 stored on a machine-readable storage medium 310 and the hardware may include a processor 311 for executing those instructions. Thus, machine-readable storage medium 310 can be said to store program instructions or code that when executed by processor 311 implements interaction flows execution system 110 of FIG. 1.

In FIG. 3, the executable program instructions in machine-readable storage medium 310 are depicted as interaction points creating instructions 321, interaction points presenting instructions 322, interaction flow obtaining instructions 323, interaction flow initiating instructions 324, interaction flow execution causing instructions 325, and response receiving instructions 326. Instructions 321-326 represent program instructions that, when executed, cause processor 311 to implement engines 121-126, respectively.

FIG. 4 is a block diagram depicting an example machine-readable storage medium 410 comprising instructions executable by a processor for execution of interaction flows.

In the foregoing discussion, engines 121-126 were described as combinations of hardware and programming. Engines 121-126 may be implemented in a number of fashions. Referring to FIG. 4, the programming may be processor executable instructions 422-425 stored on a machine-readable storage medium 410 and the hardware may include a processor 411 for executing those instructions. Thus, machine-readable storage medium 410 can be said to store program instructions or code that when executed by processor 411 implements interaction flows execution system 110 of FIG. 1.

In FIG. 4, the executable program instructions in machine-readable storage medium 410 are depicted as interaction points presenting instructions 422, interaction flow obtaining instructions 423, interaction flow initiating instructions 424, and interaction flow execution causing instructions 425. Instructions 422-425 represent program instructions that, when executed, cause processor 411 to implement engines 122-125, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices. Further, machine-readable storage medium 310 (or machine-readable storage medium 410) may be fully or partially integrated in the same device as processor 311 (or processor 411), or it may be separate but accessible to that device and processor 311 (or processor 411).

In one example, the program instructions may be part of an installation package that when installed can be executed by processor 311 (or processor 411) to implement interaction flows execution system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid, state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321-326, and/or other instructions. As an alternative or in addition to retrieving and executing instructions, processor 311 may include at least one electronic circuit comprising a number of electronic components for performing the functionality of at least one of instructions 321-326, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 422-425, and/or other instructions. As an alternative or in addition to retrieving and executing instructions, processor 411 may include at least one electronic circuit comprising a number of electronic components for performing the functionality of at least one of instructions 422-425, and/or other instructions.

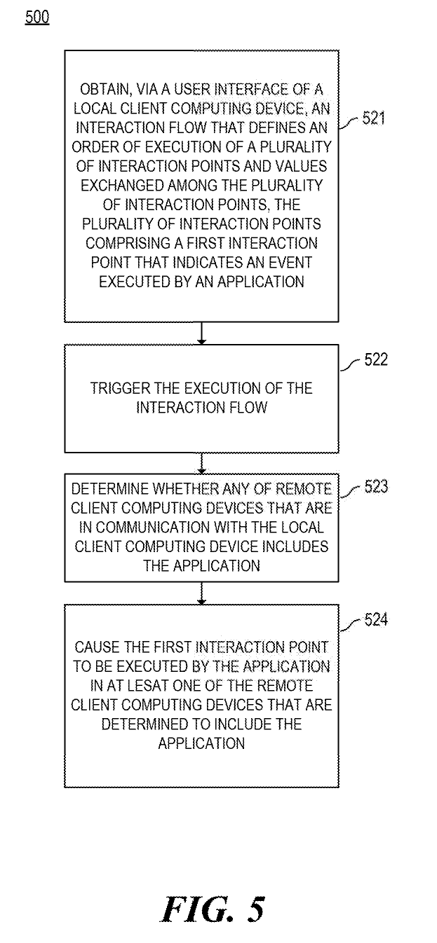

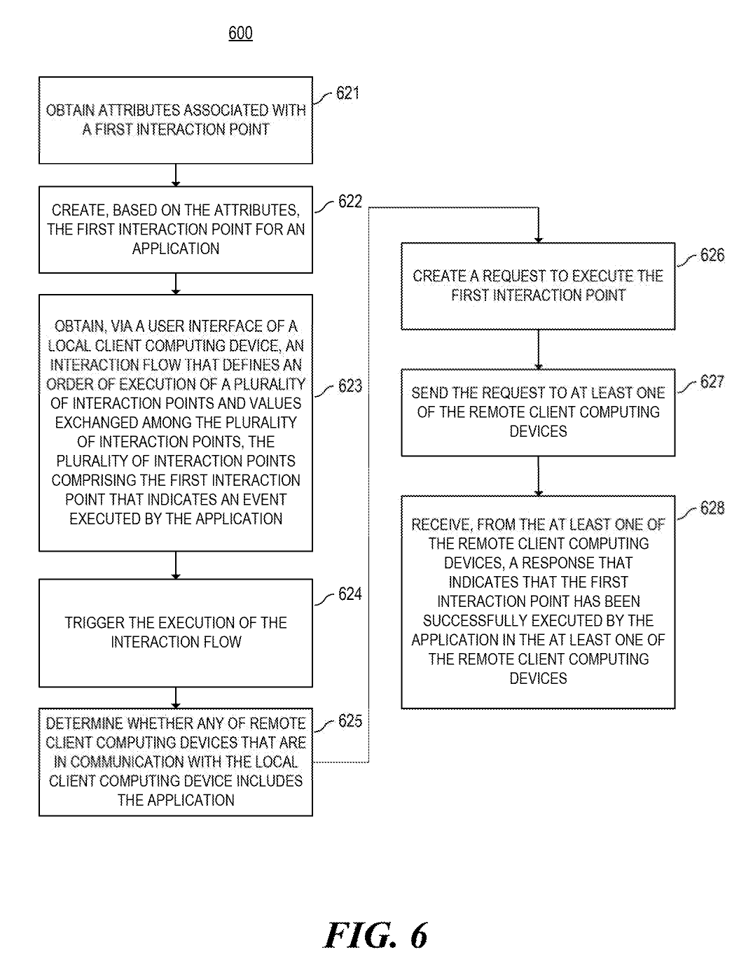

FIG. 5 is a flow diagram depicting an example method 500 for execution of interaction flows. The various processing blocks and/or data flows depicted in FIG. 5 (and in the other drawing figures such as FIG. 6) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in, greater detail below) is meant be an example and, as such, should not be viewed as limiting. Method 500 may be implemented in the form of executable instructions stored on a machine-readable storage medium, such as storage medium 310, and/or in the form of electronic circuitry.

Method 500 may start in block 521 where an interaction flow may be obtained via a user interface of a local client computing device. The interaction flow may define an order of execution of a plurality of interaction points and/or values exchanged among the plurality of interaction points. The plurality of interaction points may comprise a first interaction point that indicates an event executed by an application. The plurality of interaction points may be executed in sequential order and/or in parallel order. The values being exchanged among the plurality of interaction points may comprise input values and/or output values. For example, an interaction point to display an email in an email application may require an input value comprising the content of the email. The content of the email may be provided by a previous interaction point as the output value of the previous interaction point.

In block 522, method 500 may trigger the execution of the interaction flow. In some implementations, the execution of the interaction flow may be triggered by initiating the interaction point that is placed at the beginning of the interaction flow. In some implementations, the execution of the interaction flow may be triggered based on an occurrence of a predefined condition. For example, when an internal device sensor such as a WiFi sensor is connected to a specific network (e.g., the user's home network), this state of the sensor and/or the state indicated by this sensor may trigger the execution of the interaction flow. In another example, the predefined condition may be related to the state of a camera sensor. The condition may be defined such that when the camera is turned on, a particular interaction flow may be executed.

In some implementations, the first interaction point may have been specified to be executed in all of the remote client computing, devices that are in communication with the local client computing device over the network. In block 523, method 500 may determine whether any of the remote client computing devices that are in communication with the local client computing device includes the application. In block 524, method 500 may cause the first interaction point to be executed by the application in at least one of the remote client computing devices that are determined to include the application. For example, the first interaction point to display the email may be executed in the remote client computing devices that are determined to include the email application.

Referring back to FIG. 1, interaction flow determine engine 123 may be responsible for implementing block 521. Interaction flow trigger engine 124 may be responsible for implementing block 522. Interaction flow execute engine 125 may be responsible for implementing blocks 523 and 524.

FIG. 6 is a flow diagram depicting an, example method 600 for execution of interaction flows. Method 600 as illustrated (and described in greater detail below) is meant be an example and, as such, should not be viewed as limiting. Method 600 may be implemented in the form of executable instructions stored on a machine-readable storage medium, such as storage medium 210, and/or in the form of electronic circuitry.

Method 600 may start in block 621 where attributes associated with a first interaction point is obtained. The attributes may comprise at least one of an interaction type or category, an interaction name (e.g., “Email Launch”), a set of input values (e.g., that are used by the application to execute the interaction point), a set of output values (e.g., that are outputted as a result of the execution of the interaction point), a interaction fulfillment type (e.g., unique, first-come, all, etc.), interaction security provisions (e.g., encryption requirement, authentication requirement, etc.), and/or other attributes, in block 622, method 600 may create, based on the obtained attributes, the first interaction point for an application.

In block 623, an interaction flow may be obtained via a user interface of a local client computing device. The interaction flow may define an order of execution of a plurality of interaction points and/or values exchanged among the plurality of interaction points. The plurality of interaction points may comprise a first interaction point that indicates an event, executed by an application. The plurality of interaction points may be executed in sequential order and/or in parallel order. The values being exchanged among the plurality of interaction points may comprise input values and/or output values. For example, an interaction point to display an email in an email application may require an input value comprising the content of the email. The content of the email may be provided by a previous interaction point as the output value of the previous interaction point.

In block 624, method 600 may trigger the execution of the interaction flow. In some implementations, the execution of the interaction flow may be triggered by initiating the interaction point that is placed at the beginning of the interaction flow. In some implementations, the execution of the interaction flow may be triggered based on an occurrence of a predefined condition. For example, when an internal device sensor such as a WiFi sensor is connected to a specific network (e.g., the users home network), this state of the sensor and/or the state indicated by this sensor may trigger the execution of the interaction flow. In another example, the predefined condition may be related to the state of a camera sensor. The condition may be defined such that when the camera is turned on, a particular interaction flow may be executed.

In some implementations, the first interaction point may have been specified to be executed in all of the remote client computing devices that are in communication with the local client computing device over the network. In block 625, method 600 may determine whether any of the remote client computing devices that are in communication with the local client computing device includes the application. For example, the first interaction point to display the email may be executed in the remote client computing devices that are determined to include the email application.

In block 626, method 600 may create a request to execute the first interaction point and send the request to at least one of the remote client computing devices (block 627). Upon receiving the request, the at least one of the remote client computing device may proceed with executing the first interaction point.

In block 628, method 600 may receive, from the at least one of the remote client computing devices, a response that indicates that the first interaction point has been successfully executed by the application in the at least one of the remote client computing devices. Based on the response that it has been successfully executed, method 600 may proceed with executing the next interaction point in the interaction flow. On the other hand, if the response indicates that the application has failed to execute the first interaction point, the failure can be further investigated and/or mitigated.

Referring back to FIG. 1, interaction points create engine 121 may be responsible for implementing blocks 621 and 622. Interaction flow determine engine 123 may be responsible for implementing block 623. Interaction flow trigger engine 124 may be responsible for implementing block 624. Interaction flow execute engine 125 may be responsible for implementing blocks 625-627. Response receive engine 126 may be responsible for implementing block 628.

The foregoing disclosure describes a number of example implementations for execution of interaction flows. The disclosed examples may include systems, devices, computer-readable storage media, and methods for execution of interaction flows. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-6 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for execution by a local client computing device for execution of interaction flows, the method comprising:
obtaining, via a user interface of the local client computing device, an interaction flow that defines an order of execution of a plurality of interaction points and values exchanged among the plurality of interaction points, the plurality of interaction points comprising a first interaction point that indicates an event executed by an application;
triggering the execution of the interaction flow;
determining whether any of remote client computing devices that are in communication with the local client computing device includes the application; and
causing the first interaction point to be executed by the application in at least one of the remote client computing devices that are determined to include the application.

2. The method of claim 1, further comprising:
obtaining attributes associated with the first interaction point, the attributes comprising at least one of an interaction type, interaction name, a set of input values, and a set of output values; and
creating, based on the attributes, the first interaction point for the application;

3. The method of claim 1, wherein causing the first interaction point to be executed in at least one of the remote client computing devices that are determined to include the application comprises:
creating a request to execute the first interaction point; and
sending the request to at least one of the remote client computing devices.

4. The method of claim 3, further comprising:
receiving, from the at least one of the remote client computing devices, a response that indicates that the first interaction point has been successfully executed by the application in the at least one of the remote client computing devices.

5. The method of claim 1, wherein the plurality of interaction points comprises a second interaction point that indicates a state of a device sensor in the first client computing device.

6. The method of claim 5, wherein triggering the execution of the interaction flow comprises:
determining when the device sensor has the state indicated by the second interaction point; and
in response to determining that the device sensor has the state indicated by the second interaction point, triggering the execution of the interaction flow.

7. A non-transitory machine-readable storage medium comprising instructions executable by a processor of a first client computing device for execution of interaction flows, the machine-readable storage medium comprising:
instructions to present, via a user interface, a plurality of interaction points comprising a first interaction point that indicates a first event executed by a first application and a second interaction point that indicates a second event executed by a second application;
instructions to obtain, via the user interface, a first interaction flow that defines an order of execution of the plurality of interaction points and values exchanged among the plurality of interaction points;
instructions to determine when the first interaction flow has been initiated;
in response to determining that the first interaction flow has been initiated, instructions to execute the first interaction point by the first application in the first client computing device; and
instructions to cause the second interaction point to be executed by the second application in a second client computing device that is coupled to the first client computing device via a network.

8. The non-transitory machine-readable storage medium of claim 7, wherein the instructions to cause the second interaction point to be executed by the second application in the second client computing device comprise:
instructions to obtain output values after the execution of the first interaction point, wherein the second interaction point is executed using the output values.

9. The non-transitory machine-readable storage medium of claim 7, wherein the plurality of interaction points comprises a third interaction point that indicates a third event executed by the first application, further comprising:
instructions to receive output values from the second client computing device after the execution of the second interaction point by the second application; and
instructions to execute the third interaction point by the first application using the output values.

10. The non-transitory machine-readable storage medium of claim 7, further comprising:
instructions to obtain local interaction points that are executable in the first client computing device;
instructions to obtain external interaction points that are executable in at least one of client computing devices that are coupled to the first client computing device via the network; and
instructions to present, via the user interface, the local and external interaction points that comprise the plurality of interaction points.

11. The non-transitory machine-readable storage medium of claim 7, further comprising:
instructions to create a second interaction flow by at least one of modifying the first interaction flow and combining the first interaction flow with a third interaction flow.

12. A system for execution of interaction flows comprising:
a server computing device coupled to a data storage that:
stores a first set of interaction points that are executable in a first client computing device and a second set of interaction points that are executable in a second client computing device; and
the server computing device comprising a processor that:
determines an interaction flow of execution of a plurality of interaction points that are selected from the first and second sets of interaction points, the plurality of interaction points comprising a first interaction point that is executable in the first client computing device and a second interaction point that is executable in the second client computing device, and
executing the interaction flow by invoking the first interaction point in the first client computing device and the second interaction point in the second client computing device.

13. The system of claim 12, wherein the first interaction point is executed by an application associated with the first interaction point in the first client computing device, and the second interaction point is executed by an application associated with the second interaction point in the second client computing device.

14. The system of claim 12, wherein the interaction flow defines an order of execution of the plurality of interaction points and values exchanged among the plurality of interaction points.

15. The system of claim 14, wherein the first and second interaction points are executed sequentially or in parallel based on the order of execution defined by the interaction flow.
